(19) United States
(12) Patent Application Publication
(10) Pub. No.: US 2008/0110979 A1
(43) Pub. Date: May 15, 2008

(54) ENHANCED BANK CARD WITH LOTTERY FEATURE

(76) Inventor: Richard E Carnation, Windsor, CA (US)

Correspondence Address: DERGOSITS & NOAH LLP, FOUR EMBARCADERO CENTER, SUITE 1450, SAN FRANCISCO, CA, 94111, US

(21) Appl. No.: 12/014,422

(22) Filed: Jan. 15, 2008

Related U.S. Application Data
(63) Continuation-in-part of application No. 11/089,693, filed on Mar. 24, 2005, now Pat. No. 7,168,616.

(51) Int. Cl. G06K 5/00

(52) U.S. Cl. 235/380

(57) ABSTRACT

A method of purchasing goods or services with use of a bank credit, debit or ATM card. The bank card is of the type issued to consumers as a means of identifying the consumers and for extending credit to consumers for the purchase of goods or services. Purchases made by consumers are tracked and purchasing information provided to a receiving body. The receiving body is authorized by consumers to purchase tickets in a lottery sanctioned by a governmental agency as to pay for lottery tickets purchased directly from the governmental agency to the extent the receiving body has logged credits based upon the consumer's card usage.

### RELATED APPLICATIONS

The present application is a continuation-in-part of U.S. application Ser. No. 11/089,693 filed on Mar. 24, 2005, which issued as U.S. Pat. No. 7,168,616 and U.S. application Ser. No. 11/204,851 filed on Aug. 16, 2005.

### TECHNICAL FIELD

The present invention relates generally to financial network systems more specifically to credit cards and include the ability of a card holder to participate in a governmental sanctioned lottery.

### BACKGROUND OF THE INVENTION

For many years, banks and other financial institutions have extended credit to consumers through the issuance of bank cards. Such cards, employing magnetic strips, holograms and other identifiers, enable consumers to purchase goods and services while credit is extended at the point of purchase. In doing so, financial institutions generally prescreen card holders establishing a credit limit which the consumer is unable to exceed.

It is well recognized that considerable risk is associated with the issuance of bank cards to customers. Each time a customer makes use of his or her bank card, unsecured credit is extended. The default rate through the use of such cards is quite high in comparison to other types of loans, particularly those in which a security interest is taken by the financial institution. Nevertheless, bank cards have proven to be an exceedingly lucrative vehicle upon which banks and other financial institutions derive income.

There are a number of factors which add to the profitability and thus success of bank cards and which support the issuance of unsecured credit with these cards notwithstanding the heightened risk. Many cards have an annual fee payable by the consumer merely for the privilege of possessing the card and enjoying the flexibility of receiving credit contemporaneous to the purchase of goods and services. In virtually all instances, the financial institution charges an interchange fee, typically about 3% or more of the dollar value of the transaction, most of which goes to the financial institution that issued the bank card, but a percentage of which is attributable to the bank card entity, such as Visa, Mastercard, Diner's Club, American Express and Discover Card. Further, if purchases are not paid by consumers within the first billing cycle subsequent to the purchase, interest rates are imposed by the lending institution or bank at rates far higher than those established for secured loans.

In light of the above, it is well recognized that financial institutions and bank card issuers profit to such an extent that certain incentives have been offered to encourage bank card ownership and usage. For example, many lending institutions waive their annual fees. Other bank cards provide consumers with incentives including cash back or cash credits, airline, hotel and vacation credits and customer perks such as travel related services which are extended to bank card holders particularly in foreign countries. As an example, several lending institutions have established pre-existing relationships with airlines whereby for each dollar attributable to a purchase employing the subject bank card, one airline mile of free travel is credited to the consumer's account. This has proven to be quite successful as many bank card holders put virtually every purchase, from common every day groceries to major appliances and even automobiles on their bank cards in order to expand their airline mile credits. The use of incentives to promote bank card usage and the enhanced profitability to bank card companies and banks and lending institutions is a proven business model which has been successfully employed for many years.

Perhaps it is a gross understatement to suggest that earnings from bank cards are quite impressive. It has been determined that there are approximately two hundred million bank cards in the United States alone, each carrying an average monthly balance of $2,500.00 noting further that card holders average $250.00 per month in new purchases. Many of these cards, particularly those providing for purchasing incentives such as airline mileage require annual fees. Further, interest rates, as noted previously, tend to be quite high because of the unsecured nature of the bank card loans. In addition, vendors who accept bank cards for purchases must pay an interchange fee to the lending institution, a portion of which also is creditable to the bank card issuing organization. Each of these component parts add to the profitability which lending institutions and bank card companies enjoy.

It is thus an object of the present invention to provide a novel incentive program to encourage the use of a specific bank credit, debit or ATM card over all others.

It is yet a further object of the present invention to provide a lottery feature to applicant's bank card to encourage use of this card over its competition.

These and further objects will be more readily apparent when considering the following disclosure and appended claims.

### SUMMARY OF THE INVENTION

A method of purchasing goods or services through the use of a bank credit, debit or ATM card, said card being issued to consumers as a means of identifying the consumers and for extending credit to the consumers for the purchase of goods or services. The method comprises tracking the purchases by said consumers and providing purchase information to a receiving body, said receiving body being authorized by said consumers to purchase tickets in a lottery sanctioned by a governmental agency.

As an alternative, lottery tickets, made available from an authorized lottery agency, can be purchased by the card holding consumer directly whereby the receiving body can communicate with the lottery agency in providing the value of “credits” based upon the credit card usage engaged in by the consumer.

### BRIEF DESCRIPTION OF THE FIGURES

The present invention is illustrated by way of example and not limited in the figures of the accompanying drawings, in which like references indicate similar elements, and in which:

FIG. 1 illustrates a network environment that can be used to implement embodiments of the present invention; and

FIGS. 2 and 3 are flow charts that illustrate the steps of the present invention according to a preferred method as described below.

### DETAILED DESCRIPTION OF THE INVENTION

The present invention is intended to, in its preferred embodiment, take advantage of electronic commerce and employs various hardware and software implementations as disclosed in parent application Ser. No. 11/089,693, filed on Mar. 24, 2005, which issued as U.S. Pat. No. 7,168,616, the disclosure of which is incorporated by reference herein. The distributed electronic commerce environment contemplated for use herein includes a computer network system that links to one or more server computers and one or more client computers, as well as server computers networked to other service computers and client computers to other client computers. The client servers and server computers include desktop personal computers, work station computers, mobile computers, portable computing devices, personal digital assistant (PDA) devices, or any other similar type of computing device. The steps of accessing, downloading and manipulating the data, as well as other aspects of the parent invention are implemented by central processing units (CPU) and the server and client computers executing sequences of instruction stored in memory. The memory can be a random access memory (RAM), read-only memory (ROM), a persistent store, such as a mass storage device, or any combination of these devices. Execution of sequences of instructions cause the CPU to perform steps according to embodiments of the present invention. Applicant's parent applications were directed to entering a bank card user into a lottery or similar game of chance based upon the amount of the user's purchases during a predetermined period of time as well as games of chance based merely upon a card holder owning a particular bank card to avoid the lottery feature aspect of the invention and thus insure that a member is compliant with regional and national prohibitions against establishing private lotteries. Prior methods involve establishing a pool for the distribution of lottery funds in direct proportion to the use of an applicant's bank card during a specific lottery period, holding the lottery, notifying lottery participants of the results. Funds for establishing the lottery pool included various elements associated with the credit card transaction, such as the typical interchange and transaction fees, interest on balance carry overs and annual fees charged by the card issuer to the user. Such proceeds can be recorded at a central facility such as a centralized computing facility.

In recognizing the limit to prohibitions against establishing personal lotteries that are not government sanctioned, one could either associate with an entity that is legally in a position to offer gaming to bank card holders, such as an American Indian reservation, or provide a lottery feature based solely upon the ownership of the appropriate bank card where lottery participation is independent of card usage. For example, payment of an annual fee could result in the issuance of a predetermined number of lottery tickets. In other words, the mere ownership of the appropriate bank card would be enough to qualify a consumer as a potential recipient of a periodically awarded prize. By doing so, the gaming aspect of lottery participation is removed. The present invention, however, facilitates what amounts to lottery participation by card holders while not engaging in unauthorized gaming activities.

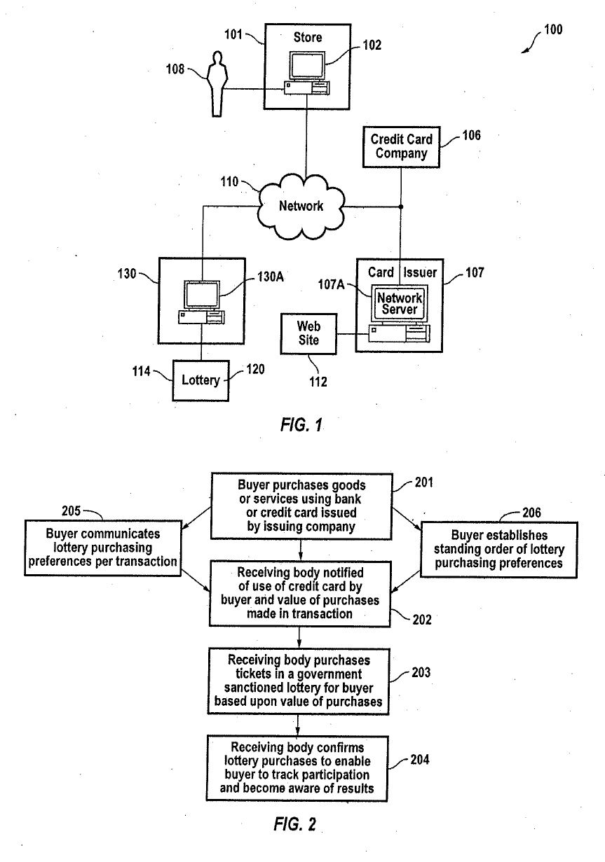

FIG. 1 illustrates an overall computing environment 100 used to implement embodiments of this invention. Program components comprising the finance and gaming aspects of the invention are executed on one or more client 102 and server 104 computers coupled through a network 110. The network 110 is a simple peer-to-peer connection, a private network (e.g., LAN), a wide area network (WAN), or the Internet. For the embodiment in which the network 110 comprises the Internet, the client and server computers communicate using an Internet protocol. In the World Wide Web environment, the network client computer 102 typically accesses the Internet network 110 through an Internet Service Provider (ISP) and execute a web browser program to display data content through web pages. In one embodiment, the web browser program is implemented using Microsoft® Internet Explorer™ browser software, but other web browser programs are also taught to be useful. For the web-based implementation, the server computer 104 executes a web server process that serves web content from a web site 112 maintained on the server computer 104.

For the client-server or Internet embodiments, the system 100 is taught to include other networked servers, such as credit card, bank or financial service computers 106, supplemental servers 103 that provide gaming or lottery services, or similar server computers. It is also noted that the network illustrated in FIG. 1 is intended to include a plurality of server computers coupled to a plurality of client computers.

In a typical bank card purchasing transaction a retail facility representing a remote purchasing location 101 accepts a bank card from a user 108 for purchase of goods or services. To accept the user's bank card, the retailer requests authorization for the purchase from a centralized computer (network server) 104 maintained by the user's bank or bank card issuer 107. Upon completion of the purchase transaction, the transfer of funds through debit of the user's account or extension of credit to the user is confirmed with network server 104, whereupon an electronic record is made of the purchase including its amount in association with the bank card holder whose identity and related information is of record with the card issuer 107.

The card issuer 107 is responsible for fulfilling the transaction between the buyer 108 and the retailer 101. The card issuer may be a bank or credit card company. Alternatively, it may be a third party financial service provider that issues credit to the buyer. In this case, the card issuer 107 may be associated with or utilize the resources of a credit card company, such as Visa® or Mastercard®, in order to provide the issuance of credit to the user.

In the practice of the present invention, consumer 108 can access a lottery server 120 which is typically done when lottery purchases are made. This can include the purchase of mega lotteries, weekly or bi-weekly drawings, daily drawings and even quick pick options. Unlike traditional lottery purchases where customer 108 would pay for lottery tickets directly, certain credits can be employed to pay for the lottery purchases emanating from card usage, i.e., dollars spent and/or transactions processed, as well as from interest received, interchange fees, annual fees and other sources of funds the bank may receive. In doing so, lottery 120, upon receipt of a purchase request from consumer 108, would access server 130A in a receiving body 130 which exchanges information with card issuer 107 and its networked server 107A. Thus, lottery tickets purchased by consumer 108 would be paid for by credits exchanged from receiving body 130 and its server 130A thus obviating the need for consumer 108 to expend further resources for such a purchase. This obviously would encourage card usage by consumer 108 as the “credits” increase through card holder usage thus increasing the number of lottery tickets available for purchase.

Alternatively, consumer 108 can deal directly with receiving body 130 by enabling receiving body 130 to track consumer spending using the appropriate bank card and bank “credits” on behalf of the consumer. Receiving body 130 can act as a “clearing house” for the purchase of lottery tickets directly on behalf of consumer 108 either due to a standing order or in the receipt of individualized purchasing instructions. For example, consumer 108 can inform receiving body 130 that each week, all banked “credits” should be used to purchase tickets of a specific lottery. Instructions could be detailed enough to provide that the receiving body only purchase lottery tickets if the lottery pool exceeds a threshold in value. Otherwise, the credits would continue to be banked within server 130A. As a further alternative, periodic instructions can be provided by consumer 108 to receiving body 130 informing the receiving body to purchase specific lottery tickets at a particular time or interval which are instructions that could change at any time through the discretion of the consumer. As noted previously, particularly if purchases are not made directly but through the receiving body 130, lottery numbers or other identifying indicia enabling consumer 108 to track identifying information and to associate it with a lottery drawing conducted at a later point in time can be included as a feature of the present invention. In addition to providing a consumer with a paper copy of lottery numbers attributable to credits provided a lottery from receiving body 130, card issuer 107 could communicate pertinent lottery information to the bank card holders through website 112. This could stimulate bank card usage.

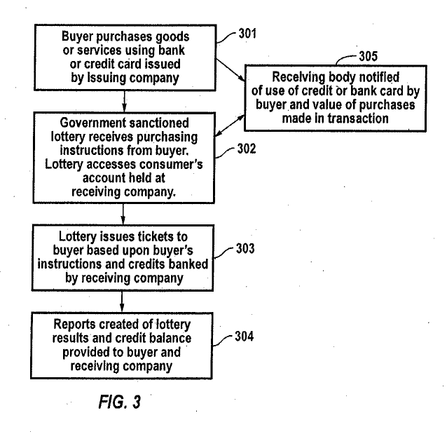

FIGS. 2 and 3 are flow charts of the present invention as described previously.

Turning first to FIG. 2, in step 201, the buyer purchases goods or services using a credit or bank card issued by an issuing company. In step 202, a receiving body is notified of the use of the bank card by the buyer and the value of purchases made in the transaction. This creates “credits” on behalf of the buyer. In step 203, the receiving body purchases tickets in a government sanctioned lottery for the consumer based upon the value of purchases or “credits.” As noted previously, this can be the result of a standing order or the result of individually placed orders at the discretion of the buyer. In step 204, the receiving body confirms lottery purchases to enable a consumer to track participation and become aware of results. As noted, this can be through the Internet. In step 205, the alternative is shown whereby the buyer communicates lottery purchase preferences at each transaction. Similarly, step 206 shows that the buyer can provide a standing order to enable the receiving body to purchase lottery tickets.

An alternative embodiment is depicted in FIG. 3. As was the case previously, 301 indicates a first step where the buyer purchases goods or services using a credit or bank card issued by an issuing company. The consumer could then directly contact a government sanctioned lottery providing purchasing instructions from the consumer while accessing the consumer's account from a suitable receiving company as indicated in step 302. Alternatively, the consumer could notify the receiving body of use of the credit card for purchases made in a transaction. This is noted in step 305 whereupon the receiving body would deal with the government sanctioned lottery directly either through a standing order placed by the consumer or by individual instructions periodically received. In step 303, the lottery would then issue tickets to the consumer based upon consumer instructions and “credits” banked by the receiving company and, as noted in step 304, the lottery results can be reported and the credit balance provided to the consumer and receiving company.

As an alternative, the lottery could deal directly with the receiving company and not the consumer in any fashion thus receiving instructions from the receiving body and providing lottery results and payouts, if any, to the receiving body. These would then be banked by the receiving body on behalf of the buyer.

In the foregoing, a system has been described integrating lottery or similar gaming features with use of a credit or bank card. Although the present invention has been described with reference to specific exemplary embodiments, it will be evident that various modifications and changes may be made to these embodiments without departing from the broader spirit and scope of the invention is set forth in the claims. Accordingly, the specification and drawings are to be regarded as illustrative rather than in a restrictive sense.

What is claimed is:

1. In a method of purchasing goods or services with use of a bank credit, debit or ATM card, said card being issued to consumers as a means of identifying the consumers and for extending credit to the consumers for the purchase of goods or serviced, the improvement comprising tracking the purchases by said consumers and providing purchase information to a receiving body, said receiving body being authorized by said consumers to purchase tickets in a lottery sanctioned by a governmental agency.

2. The method of claim 1 wherein the number of tickets purchased by said receiving body is directly proportional to the extent of said purchases.

3. The method of claim 1 wherein said consumers communicate lottery purchasing preferences.

4. The method of claim 3 wherein said consumers provide an initial standing order to said receiving body of their lottery purchasing preferences.

5. The method of claim 3 wherein said consumers provide ongoing instructions to said receiving body of the lottery purchasing preferences.

6. In a method of purchasing goods or services with use of a bank card, said card being issued to consumers as a means of identifying the consumers and for extending credit to consumers for the purchase of goods or services, the improvement comprising tracking the purchases by said consumers and providing purchase information to a receiving body, purchasing lottery tickets from an authorized lottery agency, providing credits based upon said purchase information to said lottery agency as funding to purchase said lottery tickets.

7. The method of claim 6 wherein said purchase information and value of credits is provided to said lottery agency by said receiving body.

8. The method of claim 6 wherein said purchase of lottery tickets is made by said consumers whereupon the issues of the lottery tickets seeks payment for said purchase from said receiving body.
